(19) United States
(12) Patent Application Publication
(10) Pub. No.: US 2016/0275848 A1
(43) Pub. Date: Sep. 22, 2016

(54) VOLTAGE OUTPUT CONTROL SYSTEM AND VOLTAGE OUTPUT SYSTEM

(71) Applicant: Shenzhen China Star Optoelectronics Technology Co. Ltd., Shenzhen, Guangdong (CN)

(72) Inventors: Xianming ZHANG, Shenzhen, Guangdong (CN); Dan CAO, Shenzhen, Guangdong (CN)

(73) Assignee: Shenzhen China Star Optoelectronics Technology Co. Ltd., Shenzhen, Guangdong (CN)

(21) Appl. No.: 14/443,640

(22) PCT Filed: Apr. 3, 2015
(86) PCT No.: PCT/CN2015/075924

§ 371 Date: May 18, 2015

(30) Foreign Application Priority Data
Mar. 19, 2015 (CN) 201510120929.2

(51) Int. Cl. G09G 3/20

(52) U.S. Cl. CPC G09G 3/2092; G09G 2310/0243; G09G 2310/08; G09G 2330/00; G09G 2360/08; G09G 2330/028

(57) ABSTRACT

The present invention discloses a voltage output control system, employed for controlling a voltage outputted from a voltage output chip, and the voltage output control system comprises a controller and a memorizer, and the memorizer saves a plurality of preset instructions, and the controller is coupled to the memorizer and the voltage output chip, and the controller is also employed for receiving a display signal and invoking corresponding preset instructions from the memorizer according to the received display signal to control the voltage output chip to output a corresponding voltage according to the invoked corresponding preset instructions. The present invention controls the voltage outputted from the voltage output chip for meeting the various requirements of the display panels for the voltage. The present invention further provides a voltage output system.

### CROSS REFERENCE

This application claims the priority of Chinese Patent Application No. 201510120929.2, entitled “Voltage output control system and voltage output system”, filed on Mar. 19, 2015, the disclosure of which is incorporated herein by reference in its entirety.

### FIELD OF THE INVENTION

The present invention relates to an electronic technology field, and more particularly to a voltage output control system and a voltage output system.

### BACKGROUND OF THE INVENTION

At present, the voltage output chip (such as a power source management chip and a P-Gamma chip) is employed for providing voltages to the display panel. Both the saved data in the power source management chip and the P-Gamma chip are externally written into the memory modules of the power source management chip and the P-Gamma chip. Thus, the data written inside the power source management chip and the P-Gamma chip cannot be amended again. When the display panel has more requirements for the voltages provided by the power source management chip and the P-Gamma chip, the power source management chip and the P-Gamma chip cannot meet the requirements of the display panel.

### SUMMARY OF THE INVENTION

An objective of the present invention is to provide a voltage output control system to control a voltage outputted from a voltage output chip for meeting the various requirements of the display panels for the voltage.

The present invention further provides a voltage output system.

For realizing the aforesaid objective, the technical solution provided by the embodiments of the present invention is:

The present invention provides a voltage output control system, employed for controlling a voltage outputted from a voltage output chip, wherein: the voltage output control system comprises a controller and a memorizer, and the memorizer saves a plurality of preset instructions, and the controller is coupled to the memorizer and the voltage output chip, and the controller is also employed for receiving a display signal and invoking corresponding preset instructions from the memorizer according to the received display signal to control the voltage output chip to output a corresponding voltage according to the invoked corresponding preset instructions.

The controller comprises a receiving unit, an invoking unit and a controlling unit, and the receiving unit is employed for receiving the display signal, and the invoking unit is employed for invoking the corresponding preset instructions from the memorizer according to the display signal, and the controlling unit is employed for outputting a corresponding control signal to the voltage output chip according to the invoked preset instructions to make the voltage output chip output the corresponding voltage.

The controller further comprises an acquiring unit, a recording unit and a judging unit, and the acquiring unit is employed for acquiring the voltage outputted from the voltage output chip, and the recording unit is employed for recording a plurality of reference voltages, and each reference voltage corresponds to a voltage period of the voltage output chip, and the judging unit is employed for judging whether the acquired voltage matches with the reference voltage of the corresponding period or not, and as the acquired voltage does not match with the reference voltage of the corresponding period, an adjustment signal is outputted to the controlling unit, and the controlling unit is further employed to output a control signal to the voltage output chip according to the adjustment signal to adjust the voltage outputted from the voltage output chip to be the reference voltage of the corresponding period.

The controller is a timer control register chip.

The memorizer is a FLASH memory.

The present invention further provides a voltage output system, comprising a first voltage output chip and a voltage output control system, the voltage output control system is coupled to the first voltage output chip to control a voltage outputted by the first voltage output chip, and the voltage output control system comprises a controller and a memorizer, and the memorizer saves a first set of preset instructions, and the controller is coupled to the memorizer and the first voltage output chip, and the controller is also employed for receiving a display signal and invoking corresponding instructions in the first set of preset instructions from the memorizer according to the received display signal to control the first voltage output chip to output a corresponding voltage according to the invoked corresponding preset instructions.

The controller comprises a receiving unit, an invoking unit and a controlling unit, and the receiving unit is employed for receiving the display signal, and the invoking unit is employed for invoking the corresponding preset instructions in the first set of the preset instructions from the memorizer according to the display signal, and the controlling unit is employed for outputting a corresponding first control signal to the first voltage output chip according to the invoked preset instructions to make the first voltage output chip output the corresponding voltage.

The controller further comprises an acquiring unit, a recording unit and a judging unit, and the acquiring unit is employed for acquiring the voltage outputted from the first voltage output chip, and the recording unit is employed for recording a first set of reference voltages, and each reference voltage in the first set of reference voltages corresponds to a voltage period of the first voltage output chip, and the judging unit is employed for judging whether the acquired voltage outputted by the first voltage output chip matches with the reference voltage of the corresponding period or not, and as the acquired voltage outputted by the first voltage output chip does not match with the reference voltage of the corresponding period, a first adjustment signal is outputted to the controlling unit, and the controlling unit outputs a first control signal to the first voltage output chip according to the first adjustment signal to adjust the voltage outputted from the first voltage output chip to be the reference voltage of the corresponding period.

The voltage output system further comprises a second voltage output chip, and the memorizer further saves a second set of the preset instructions, and the controller is further coupled to the second voltage output chip, and the controller is also employed for invoking corresponding instructions in the second set of preset instructions from the memorizer according to the received display signal to control the second voltage output chip to output a corresponding voltage according to the invoked corresponding preset instructions.

The invoking unit is also employed for invoking the corresponding preset instructions in the second set of the preset instructions from the memorizer according to the display signal, and the controlling unit is also employed for outputting a second control signal to the second voltage output chip according to the invoked preset instructions to make the second voltage output chip output the corresponding voltage.

The acquiring unit is employed for acquiring the voltage outputted from the second voltage output chip, and the recording unit is employed for recording the second set of reference voltages, and each reference voltage in the second set of reference voltages corresponds to a voltage period of the second voltage output chip, and the judging unit is employed for judging whether the acquired voltage outputted by the second voltage output chip matches with the reference voltage of the corresponding period or not, and as the acquired voltage outputted by the second voltage output chip does not match with the reference voltage of the corresponding period, a second adjustment signal is outputted to the controlling unit, and the controlling unit is further employed to output a second control signal to the second voltage output chip according to the second adjustment signal to adjust the voltage outputted from the second voltage output chip to be the reference voltage of the corresponding period.

The first voltage output chip is a power source management chip, and the second voltage output chip is a P-Gamma chip.

The controller is a timer control register chip.

The memorizer is a FLASH memory.

The present invention provides a voltage output control system, employed for controlling a voltage outputted from a voltage output chip, wherein: the voltage output control system comprises a controller and a memorizer, and the memorizer saves a plurality of preset instructions, and the controller is coupled to the memorizer and the voltage output chip, and the controller is also employed for receiving a display signal and invoking corresponding preset instructions from the memorizer according to the received display signal to control the voltage output chip to output a corresponding voltage according to the invoked corresponding preset instructions. Therefore, the voltage outputted from the voltage output chip can be adjusted according to the display signal of the display panel for outputting the voltages meeting the requirements of the display panels.

### BRIEF DESCRIPTION OF THE DRAWINGS

In order to more clearly illustrate the embodiments of the present invention, the following figures will be described in the embodiments are briefly introduced. It is obvious that the drawings are only some embodiments of the present invention, those of ordinary skill in this field can obtain other figures according to these figures without paying the premise.

FIG. 1 is an application block diagram of a voltage output control system provided by the first embodiment of the first solution according to the present invention;

FIG. 2 is an application block diagram of a voltage output control system provided by the second embodiment of the first solution according to the present invention;

FIG. 3 is an application block diagram of a voltage output control system provided by the first preferable embodiment of the second solution according to the present invention;

FIG. 4 is an application block diagram of a voltage output control system provided by the second preferable embodiment of the second solution according to the present invention.

### DETAILED DESCRIPTION OF PREFERRED EMBODIMENTS

For better explaining the technical solution and the effect of the present invention, the present invention will be further described in detail with the accompanying drawings in the specific embodiments.

It will be understood that when an element or layer is referred to as being “on”, “connected to” or “coupled to” another element or layer, it can be directly on the other element or layer or intervening elements or layers may be present. In contrast, when an element is referred to as being “directly on”, “directly connected to” or “directly coupled to” another element or layer, there are no intervening elements or layers present. Like numbers indicate like elements throughout. As used herein, the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “below”, “beneath”, “lower”, “above”, “upper” and the like, may be used herein for ease of description to describe one element or feature's relationship to another element(s) or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Please refer to FIG. 1. The first embodiment of the first solution according to the present invention provides a voltage output control system 100. The voltage output control system 100 is employed for controlling a voltage outputted by a voltage output chip 1000. The voltage output control system 100 comprises a controller 10 and a memorizer 20. The memorizer 20 saves a plurality of preset instructions. The controller 10 is coupled to the memorizer 20 and the voltage output chip 1000. The controller 10 is also employed for receiving a display signal and invoking corresponding preset instructions from the memorizer 20 according to the received display signal to control the voltage output chip 1000 to output a corresponding voltage according to the invoked corresponding preset instructions.

Specifically, the controller 10 is coupled to the memorizer 20 and the voltage output chip 1000 with a two-wire serial bus. The plurality of preset instructions saved in the memorizer 20 is burned beforehand. During the process of powering on the controller 10, the memorizer 20 and the voltage output chip 1000, 3.3V and 1.2V voltages are first inputted to activate the controller 10 and the memorizer 20. The display signal is from a display panel. The display signal comprises an image signal, a mode state signal and et cetera.

In this embodiment, the voltage output control system 100 comprises a controller 10 and a memorizer 20. The memorizer 20 saves a plurality of preset instructions. The controller 10 is coupled to the memorizer 20 and the voltage output chip 1000. The controller 10 is also employed for receiving a display signal and invoking corresponding preset instructions from the memorizer 20 according to the received display signal to control the voltage output chip 1000 to output a corresponding voltage according to the invoked corresponding preset instructions. Therefore, the voltage outputted from the voltage output chip 1000 can be adjusted according to the display signal of the display panel for outputting the voltages meeting the requirements of the display panels.

Specifically, the controller 10 comprises a receiving unit 11, an invoking unit 12 and a controlling unit 13. The receiving unit 11 is employed for receiving the display signal. The invoking unit 12 is employed for invoking the corresponding preset instructions from the memorizer 20 according to the display signal. The controlling unit 13 is employed for outputting a corresponding control signal to the voltage output chip 1000 according to the invoked preset instructions to make the voltage output chip 1000 output the corresponding voltage.

In this embodiment, the controller 10 is a timer control register chip. The memorizer 20 is a FLASH memory.

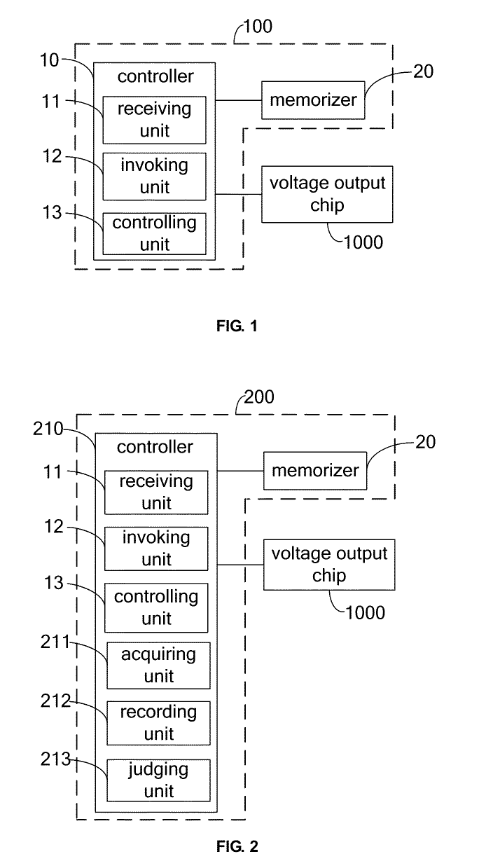

Please refer to FIG. 2. The second embodiment of the first solution according to the present invention provides a voltage output control system 200. The voltage output control system 200 provided by the second embodiment is similar with the voltage output control system 100 provided by the first embodiment. The difference between the two is: in the second embodiment, the controller 210 further comprises an acquiring unit 211, a recording unit 212 and a judging unit 213. The acquiring unit 211 is employed for acquiring the voltage outputted from the voltage output chip 1000. The recording unit 212 is employed for recording a plurality of reference voltages. Each reference voltage corresponds to a voltage period of the voltage output chip 1000. The judging unit 213 is employed for judging whether the acquired voltage matches with the reference voltage of the corresponding period or not, and as the acquired voltage does not match with the reference voltage of the corresponding period, an adjustment signal is outputted to the controlling unit 13. The controlling unit 13 is further employed to output a control signal to the voltage output chip 1000 according to the adjustment signal to adjust the voltage outputted from the voltage output chip 1000 to be the reference voltage of the corresponding period.

Specifically, the voltage output chip 1000 has a plurality of voltage periods, and each voltage period requires outputting a corresponding preset voltage. Consequently, the preset voltage corresponding to each voltage period is burned beforehand into the recording unit 212 to be a reference voltage.

In this embodiment, the recording unit 212 is employed for recording a plurality of reference voltages. Each reference voltage corresponds to a voltage period of the voltage output chip 1000. The judging unit 213 is employed for judging whether the acquired voltage matches with the reference voltage of the corresponding period or not, and as the acquired voltage does not match with the reference voltage of the corresponding period, an adjustment signal is outputted to the controlling unit 13. The controlling unit 13 is further employed to output a control signal to the voltage output chip 1000 according to the adjustment signal to adjust the voltage outputted from the voltage output chip 1000 to be the reference voltage of the corresponding period. Therefore, the embodiment establishes a response mechanism for ensuring that the voltage outputted from the voltage output chip 1000 in each period is correct.

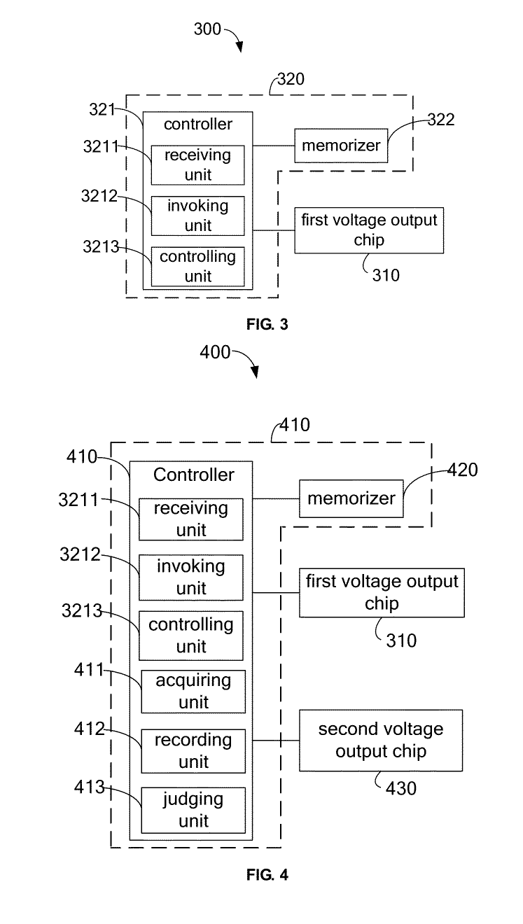

Please refer to FIG. 3. The first preferable embodiment of the second solution according to the present invention provides a voltage output control system 300. The voltage output control system 300 comprises a first voltage output chip 310 and a voltage output control system 320. The voltage output control system 320 is coupled to the first voltage output chip 310 to control a voltage outputted by the first voltage output chip 310. The voltage output control system 320 comprises a controller 321 and a memorizer 322. The memorizer 322 saves a first set of preset instructions. The controller 320 is coupled to the memorizer 322 and the first voltage output chip 310. The controller 321 is also employed for receiving a display signal and invoking corresponding instructions in the first set of preset instructions from the memorizer 322 according to the received display signal to control the first voltage output chip 310 to output a corresponding voltage according to the invoked corresponding preset instructions.

Specifically, the controller 321 is coupled to the memorizer 322 and the first voltage output chip 310 with a two-wire serial bus. The plurality of preset instructions saved in the memorizer 322 is burned beforehand. During the process of powering on the controller 321, the memorizer 322 and the voltage output chip 310, 3.3V and 1.2V voltages are first inputted to activate the controller 321 and the memorizer 322. The display signal is from a display panel. The display signal comprises an image signal, a mode state signal and et cetera.

In this embodiment, the voltage output control system 320 comprises a controller 321 and a memorizer 322. The memorizer 322 saves a first set of preset instructions. The controller 320 is coupled to the memorizer 322 and the first voltage output chip 310. The controller 321 is also employed for receiving a display signal and invoking corresponding instructions in the first set of preset instructions from the memorizer 322 according to the received display signal to control the first voltage output chip 310 to output a corresponding voltage according to the invoked corresponding preset instructions. Therefore, the voltage outputted from the first voltage output chip 310 can be adjusted according to the display signal of the display panel for outputting the voltages meeting the requirements of the display panels.

Specifically, the controller 321 comprises a receiving unit 3211, an invoking unit 3212 and a controlling unit 3213. The receiving unit 3211 is employed for receiving the display signal. The invoking unit 3212 is employed for invoking the corresponding preset instructions in the first set of the preset instructions from the memorizer 322 according to the display signal. The controlling unit 3213 is employed for outputting a corresponding first control signal to the first voltage output chip 310 according to the invoked preset instructions to make the first voltage output chip 310 output the corresponding voltage.

In this embodiment, the controller 321 is a timer control register chip. The memorizer 322 is a FLASH memory.

Please refer to FIG. 4. The second preferable embodiment of the second solution according to the present invention provides a voltage output control system 400. The voltage output system 400 provided by the second embodiment is similar with the voltage output system 300 provided by the first embodiment. The difference between the two is: in the second embodiment, the controller 410 further comprises an acquiring unit 411, a recording unit 412 and a judging unit 413. The acquiring unit 411 is employed for acquiring the voltage outputted from the first voltage output chip 310. The recording unit 412 is employed for recording the first set of reference voltages. Each reference voltage in the first set of reference voltages corresponds to a voltage period of the first voltage output chip 310. The judging unit 413 is employed for judging whether the acquired voltage outputted by the first voltage output chip 310 matches with the reference voltage of the corresponding period or not, and as the acquired voltage outputted by the first voltage output chip 310 does not match with the reference voltage of the corresponding period, a first adjustment signal is outputted to the controlling unit 3213. The controlling unit 3213 is further employed to output a first control signal to the first voltage output chip 310 according to the first adjustment signal to adjust the voltage outputted from the first voltage output chip 310 to be the reference voltage of the corresponding period.

Specifically, the voltage output chip 310 has a plurality of voltage periods. Each voltage period requires outputting a corresponding preset voltage. Consequently, the preset voltage corresponding to each voltage period is burned beforehand into the recording unit 412 to be a reference voltage.

In this embodiment, the recording unit 412 is employed for recording the first set of reference voltages. Each reference voltage in the first set of reference voltages corresponds to a voltage period of the first voltage output chip 310. The judging unit 413 is employed for judging whether the acquired voltage outputted by the first voltage output chip 310 matches with the reference voltage of the corresponding period or not, and as the acquired voltage outputted by the first voltage output chip 310 does not match with the reference voltage of the corresponding period, a first adjustment signal is outputted to the controlling unit 3213. The controlling unit 3213 is further employed to output a first control signal to the first voltage output chip 310 according to the first adjustment signal to adjust the voltage outputted from the first voltage output chip 310 to be the reference voltage of the corresponding period. Therefore, the embodiment establishes a response mechanism for ensuring that the voltage outputted from the first voltage output chip 310 in each period is correct.

Furthermore, the voltage output system 400 further comprises a second voltage output chip 430. The memorizer 420 further saves a second set of the preset instructions. The controller 410 is further coupled to the second voltage output chip 430. The controller 410 is also employed for invoking corresponding instructions in the second set of preset instructions from the memorizer 420 according to the received display signal to control the second voltage output chip 430 to output a corresponding voltage according to the invoked corresponding preset instructions.

The controller 410 is coupled to the second voltage output chip 430 with a two-wire serial bus. The second set of preset instructions saved in the memorizer 420 is burned beforehand.

In this embodiment, the memorizer 420 saves the second set of the preset instructions. The controller 410 is coupled to the memorizer 420 and the second voltage output chip 430. The controller 410 is also employed for receiving the display signal and invoking corresponding instructions in the second set of preset instructions from the memorizer 420 according to the received display signal to control the second voltage output chip 430 to output a corresponding voltage according to the invoked corresponding preset instructions. Therefore, the voltage outputted from the second voltage output chip 430 can be adjusted according to the display signal of the display panel for outputting the voltages meeting the requirements of the display panels.

Specifically, the invoking unit 3212 is also employed for invoking the corresponding preset instructions in the second set of the preset instructions from the memorizer 420 according to the display signal. The controlling unit 3213 is also employed for outputting a second control signal to the second voltage output chip 430 according to the invoked preset instructions to make the second voltage output chip 430 output the corresponding voltage.

The acquiring unit 411 is employed for acquiring the voltage outputted from the second voltage output chip 430. The recording unit 412 is employed for recording the second set of reference voltages. Each reference voltage in the second set of reference voltages corresponds to a voltage period of the second voltage output chip 430. The judging unit 413 is employed for judging whether the acquired voltage outputted by the second voltage output chip 430 matches with the reference voltage of the corresponding period or not, and as the acquired voltage outputted by the second voltage output chip 430 does not match with the reference voltage of the corresponding period, a second adjustment signal is outputted to the controlling unit 3213. The controlling unit 3213 is further employed to output a second control signal to the second voltage output chip 430 according to the second adjustment signal to adjust the voltage outputted from the second voltage output chip 430 to be the reference voltage of the corresponding period.

In this embodiment, the first voltage output chip 410 is a power source management chip. The second voltage output chip 430 is a P-Gamma chip.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A voltage output control system, employed for controlling a voltage outputted from a voltage output chip, wherein: the voltage output control system comprises a controller and a memorizer, and the memorizer saves a plurality of preset instructions, and the controller is coupled to the memorizer and the voltage output chip, and the controller is also employed for receiving a display signal and invoking corresponding preset instructions from the memorizer according to the received display signal to control the voltage output chip to output a corresponding voltage according to the invoked corresponding preset instructions.

2. The voltage output control system according to claim 1, wherein the controller comprises a receiving unit, an invoking unit and a controlling unit, and the receiving unit is employed for receiving the display signal, and the invoking unit is employed for invoking the corresponding preset instructions from the memorizer according to the display signal, and the controlling unit is employed for outputting a corresponding control signal to the voltage output chip according to the invoked preset instructions to make the voltage output chip output the corresponding voltage.

3. The voltage output control system according to claim 2, wherein the controller further comprises an acquiring unit, a recording unit and a judging unit, and the acquiring unit is employed for acquiring the voltage outputted from the voltage output chip, and the recording unit is employed for recording a plurality of reference voltages, and each reference voltage corresponds to a voltage period of the voltage output chip, and the judging unit is employed for judging whether the acquired voltage matches with the reference voltage of the corresponding period or not, and as the acquired voltage does not match with the reference voltage of the corresponding period, an adjustment signal is outputted to the controlling unit, and the controlling unit is further employed to output a control signal to the voltage output chip according to the adjustment signal to adjust the voltage outputted from the voltage output chip to be the reference voltage of the corresponding period.

4. The voltage output control system according to claim 1, wherein the controller is a timer control register chip.

5. The voltage output control system according to claim 4, wherein the memorizer is a FLASH memory.

6. A voltage output system, comprising a first voltage output chip and a voltage output control system, the voltage output control system is coupled to the first voltage output chip to control a voltage outputted by the first voltage output chip, and the voltage output control system comprises a controller and a memorizer, and the memorizer saves a first set of preset instructions, and the controller is coupled to the memorizer and the first voltage output chip, and the controller is also employed for receiving a display signal and invoking corresponding instructions in the first set of preset instructions from the memorizer according to the received display signal to control the first voltage output chip to output a corresponding voltage according to the invoked corresponding preset instructions.

7. The voltage output system according to claim 6, wherein the controller comprises a receiving unit, an invoking unit and a controlling unit, and the receiving unit is employed for receiving the display signal, and the invoking unit is employed for invoking the corresponding preset instructions in the first set of the preset instructions from the memorizer according to the display signal, and the controlling unit is employed for outputting a corresponding first control signal to the first voltage output chip according to the invoked preset instructions to make the first voltage output chip output the corresponding voltage.

8. The voltage output system according to claim 7, wherein the controller further comprises an acquiring unit, a recording unit and a judging unit, and the acquiring unit is employed for acquiring the voltage outputted from the first voltage output chip, and the recording unit is employed for recording the first set of reference voltages, and each reference voltage in the first set of reference voltages corresponds to a voltage period of the first voltage output chip, and the judging unit is employed for judging whether the acquired voltage outputted by the first voltage output chip matches with the reference voltage of the corresponding period or not, and as the acquired voltage outputted by the first voltage output chip does not match with the reference voltage of the corresponding period, a first adjustment signal is outputted to the controlling unit, and the controlling unit outputs a first control signal to the first voltage output chip according to the first adjustment signal to adjust the voltage outputted from the first voltage output chip to be the reference voltage of the corresponding period.

9. The voltage output system according to claim 8, wherein the voltage output system further comprises a second voltage output chip, and the memorizer further saves a second set of the preset instructions, and the controller is further coupled to the second voltage output chip, and the controller is also employed for invoking corresponding instructions in the second set of preset instructions from the memorizer according to the received display signal to control the second voltage output chip to output a corresponding voltage according to the invoked corresponding preset instructions.

10. The voltage output system according to claim 9, wherein the invoking unit is also employed for invoking the corresponding preset instructions in the second set of the preset instructions from the memorizer according to the display signal, and the controlling unit is also employed for outputting a second control signal to the second voltage output chip according to the invoked preset instructions to make the second voltage output chip output the corresponding voltage.

11. The voltage output system according to claim 10, wherein the acquiring unit is employed for acquiring the voltage outputted from the second voltage output chip, and the recording unit is employed for recording the second set of reference voltages, and each reference voltage in the second set of reference voltages corresponds to a voltage period of the second voltage output chip, and the judging unit is employed for judging whether the acquired voltage outputted by the second voltage output chip matches with the reference voltage of the corresponding period or not, and as the acquired voltage outputted by the second voltage output chip does not match with the reference voltage of the corresponding period, a second adjustment signal is outputted to the controlling unit, and the controlling unit is further employed to output a second control signal to the second voltage output chip according to the second adjustment signal to adjust the voltage outputted from the second voltage output chip to be the reference voltage of the corresponding period.

12. The voltage output system according to claim 9, wherein the first voltage output chip is a power source management chip, and the second voltage output chip is a P-Gamma chip.

13. The voltage output system according to claim 9, wherein the controller is a timer control register chip.

14. The voltage output system according to claim 9, wherein the memorizer is a FLASH memory.
